(19) United States
(12) Patent Application Publication
(10) Pub. No.: US 2023/0276102 A1
(43) Pub. Date: Aug. 31, 2023

(54) OBJECT-BASED VIDEO COMMENTING

(71) Applicant: ARRIS Enterprises LLC, Suwanee, GA (US)

(72) Inventors: Ji CHEN, Shanghai (CN); Yu'an CHEN, Shanghai (CN); Kunming REN, Shanghai (CN); Xiang SHEN, Shanghai (CN); Yeyi CUI, Shanghai (CN)

(73) Assignee: ARRIS Enterprises LLC, Suwanee, GA (US)

(21) Appl. No.: 17/437,592

(22) PCT Filed: Nov. 16, 2020
(86) PCT No.: PCT/CN2020/128998

§ 371 Date: Sep. 9, 2021

(51) Int. Cl. H04N 21/4788; H04N 21/431; H04N 21/472; G06T 7/70

(52) U.S. Cl. CPC H04N 21/4788; H04N 21/431; H04N 21/47217; G06T 7/70; G06T 2207/20084

(57) ABSTRACT

A method, system, and computer program product for object-based commenting in an on-demand video includes a processor to receive an on-demand video file selection from a first user for display on a first user device. The processor can receive a first user input pausing the video file at a scene from the first via a first graphical user interface. The processor can receive a second user input from the first user via a first graphical user interface. The second user input can include an object identification and a user comment associated with the object. The processor can identify the object in the scene of the video file based on the object identification and display the second input from the first user to one or more second users via one or more second graphical user interfaces with the identified object over the scene of the video file.

### FIELD OF THE DISCLOSURE

The present disclosure relates generally to a method, system, and computer program product for object-based video commenting, and more particularly to enabling users to associate user inputs with specific objects in a video.

### BACKGROUND

User commenting in on-demand videos has become increasing popular in recent years, especially in Asia-Pacific countries. One particularly popular application for user commenting in on-demand videos is known as a bullet screen. Originating in Japan, the bullet screen or “danmaku” in Japanese enables viewers of uploaded videos to enter comments which are then displayed directly on top of the uploaded videos. Thus, the individual viewers are able to interact with one another while watching the same uploaded video. In a bullet screen interface, viewers enter comments via an input box and the input is then sent to the server hosting the video which then displays the comments as a scrolling comment across the screen on top of the video. The comments scroll across the screen fairly quickly; thus, resembling a “bullet” shooting across the screen and hence the name “bullet screen.” In current bullet screen interfaces, the user comments from all viewers of a video are collected by a server and displayed via the bullet screen interface in a scrolling format across the screen irrespective of the subject of the comments. Thus, there is a need for a technical solution for associating user inputs with specific objects or points of interest in the video.

### SUMMARY OF THE DISCLOSURE

The present disclosure provides a description of exemplary methods, systems, and computer program products for object-based commenting in an on-demand video. The methods, systems, and computer program products may include a processor which can receive an on-demand video file selection from a first user for display on a first user device. The processor may receive a first user input pausing the video file at a scene from the first user via a first graphical user interface. The process can receive a second user input from the first user via a first graphical user interface. The second user input can include an object identification and a user comment associated with the object. The processor can identify the object in the scene of the video file based on the object identification and display the second input to one or more second users on one or more second user devices via one or more second graphical user interfaces. The second user input is displayed with the identified object over the scene of the video file.

Further exemplary methods, systems, and computer program products for object-based commenting in an on-demand video may include a processor which can receive an on-demand video file selection from a first user for display on a first user device. The processor can receive a first user input pausing the video file at a scene from the first user via a first graphical user interface. The processor can receive a user selection of an area of the scene, the area including an object. The processor can receive a second user input from the first user via a first graphical user interface. The second user input can be associated with the object in the selected area. The processor can display the second input from the first user to one or more second users on one or more second user devices via one or more second graphical user interfaces. The second user input can be displayed over the scene of the video file in the selected area.

Further exemplary methods, systems, and computer program products for object-based commenting in an on-demand video may include a processor which can receive an on-demand video file selection from a first user for display on a first user device. The processor can receive a first user input pausing the video file at a scene from the first user via a first graphical user interface. The processor can identify one or more user selectable objects in the scene using object detection and present the one or more user selectable objects associated with the scene to the first user via the first graphical user interface. The processor can receive a user selection of one of the one or more user selectable objects via the first graphical user interface. The processor can receive a second user input from the first user on the first user device via a first graphical user interface. The second user input can be associated with the selected object. The processor can display the second input from the first user to one or more second users over the scene of the video file via one or more second graphical user interfaces.

### BRIEF DESCRIPTION OF THE DRAWINGS

The scope of the present disclosure is best understood from the following detailed description of exemplary embodiments when read in conjunction with the accompanying drawings. Included in the drawings are the following figures:

FIG. 1a is a block diagram that illustrating a high-level system architecture for object-based video commenting in accordance with exemplary embodiments;

FIG. 1b illustrates example operating modules of the object-based video commenting program of FIG. 1a in accordance with exemplary embodiments;

FIG. 1c illustrates an example graphical user interface in accordance with exemplary embodiments;

FIG. 2 is a flow chart illustrating exemplary methods for object-based video commenting in accordance with exemplary embodiments;

FIG. 3 is a flow chart illustrating exemplary methods for object-based video commenting in accordance with exemplary embodiments;

FIG. 4 is a flow chart illustrating exemplary methods for object-based video commenting in accordance with exemplary embodiments; and

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure

### DETAILED DESCRIPTION OF THE PREFERRED EMBODIMENTS AND METHODS

The present disclosure provides a novel solution for object-based commenting in an on-demand video. In current bullet screen interfaces, user comments from all viewers of a video are collected by a server and displayed on top of the video via the bullet screen interface regardless of the subject of the comments. Bullet screens can be generated in a number of ways, such as disclosed in US20160366466A1, US20170251240A1, US20170171601A1, herein incorporated by reference. Thus, in current technology, is not possible for viewers to associate a comment or user input with a particular object in a video. Thus, in current on-demand video commenting, where the comments are displayed on top of the video, a viewer must read a comment scrolling across the screen, determine if the comment references an object in the video, and mentally associate the comment with the object in the video in a short period of time. The methods, systems, and computer program products herein provide a novel solution, not addressed by current technology, by enabling user to associate a comment with a particular object or point of interest in an on-demand video. Exemplary embodiments of the methods, systems, and computer program products provided for herein analyzes a user input using natural language processing to identify an object/point of interest within the video, associate the input with that object/point of interest, and displays that input with the identified object and/or point of interest. Exemplary embodiments of the methods, systems, and computer program products provided for herein may receive a user selection of an area of a scene in a video in which a user input is to be displayed and associate the comments with an object as metadata having a timestamp or frame numbers, for example. Further, embodiments of the methods, systems, and computer program products provided for herein may identify objects on a paused/stopped scene of an on-demand video using object detection, present the identified objects to a user, receive a user selection of an identified object and a user input, and displaying the user input with the identified object on the scene of the video. Thus, the methods, systems, and computer program products provided for herein provide a novel way for a user to associate a user input with an object and/or point of interest in an on-demand video.

### System for Object-Based Commenting in an On-Demand Video

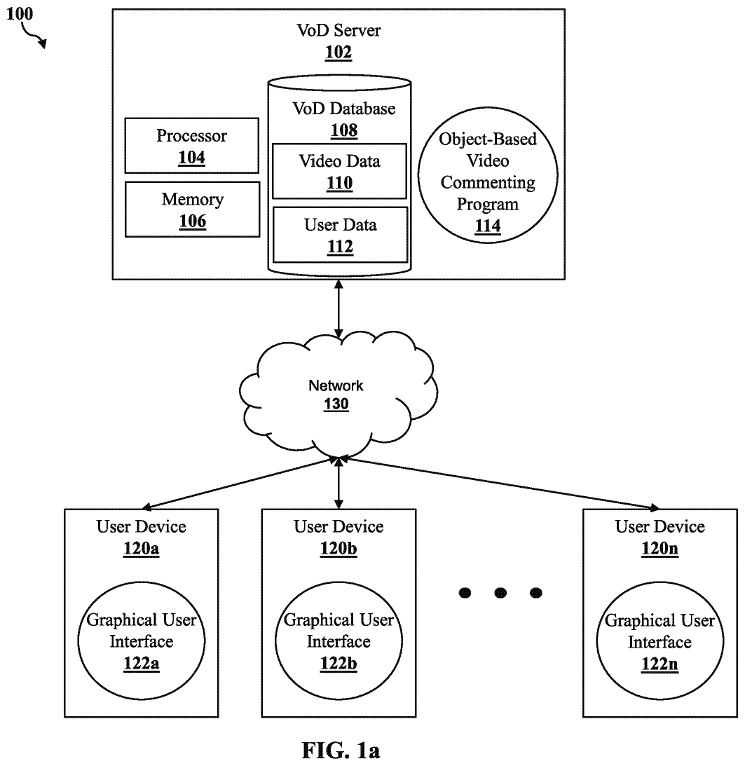

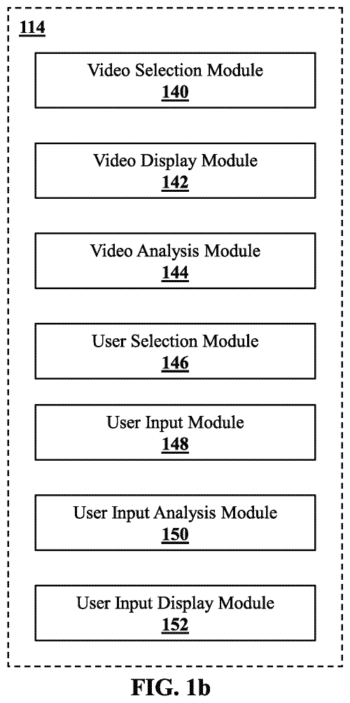

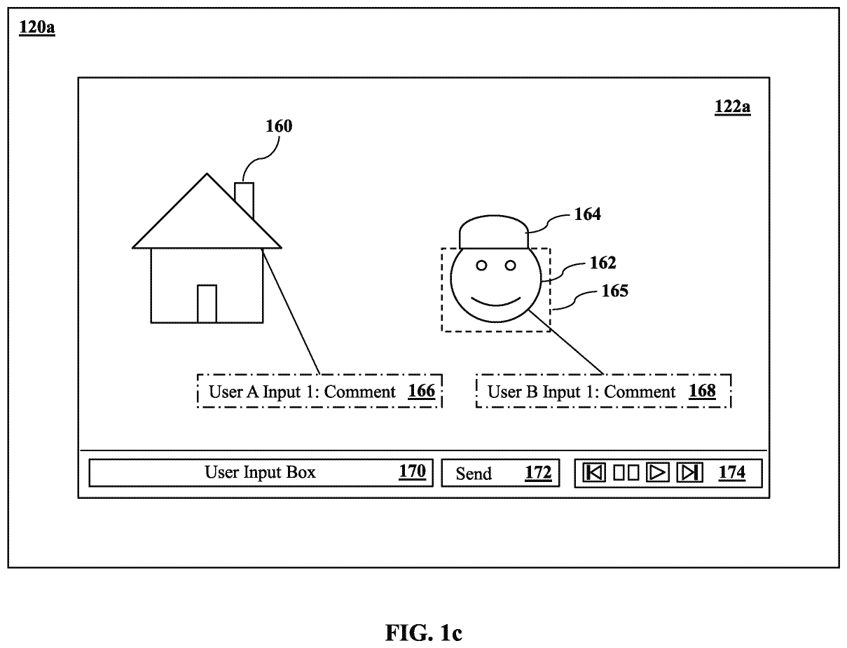

FIG. 1a illustrates an exemplary system 100 for object-based commenting in an on-demand video. The system 100 includes a Video-on-Demand (VoD) Server 102 and user devices 120a-n communicating via a network 130.

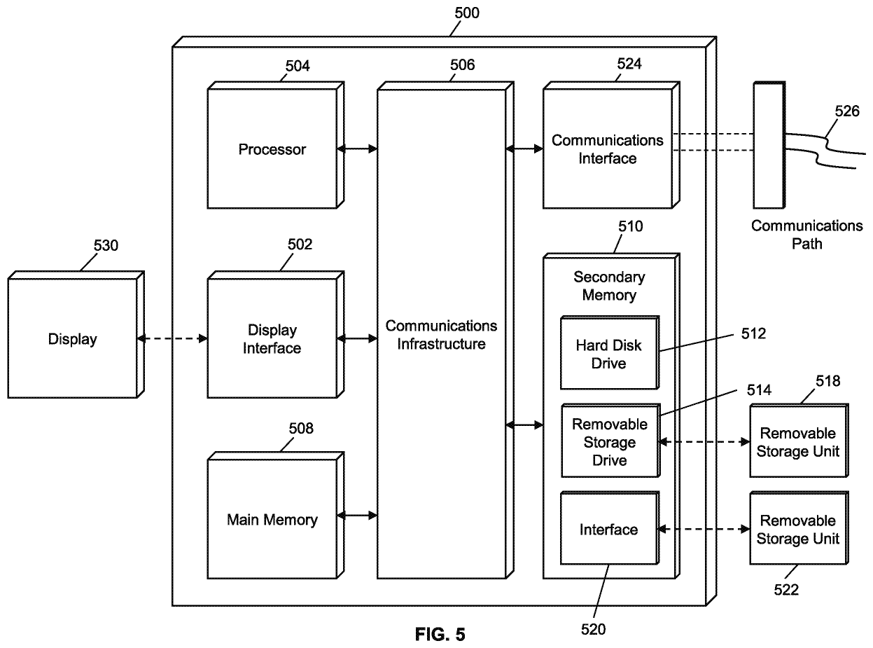

The VoD server 102 includes, for example, a processor 104, a memory 106, a VoD database 108, and an object-based video commenting program 114. The VoD server 102 may be any type of electronic device or computing system specially configured to perform the functions discussed herein, such as the computing system 500 illustrated in FIG. 5. Further, it can be appreciated that the VoD server 102 may include one or more computing devices. In an exemplary embodiment of the system 100, the VoD server 102 is a server associated with any media services provider providing a Video-on-Demand (VoD) service.

The processor 104 may be a special purpose or a general purpose processor device specifically configured to perform the functions discussed herein. The processor 104 unit or device as discussed herein may be a single processor, a plurality of processors, or combinations thereof. Processor devices may have one or more processor “cores.” In an exemplary embodiment, the processor 104 is configured to perform the functions associated with the modules of the object-based video commenting program 114 as discussed below with reference to FIGS. 1b-4.

The memory 106 can be a random access memory, read-only memory, or any other known memory configurations. Further, the memory 106 can include one or more additional memories including the VoD database 108 in some embodiments. The memory and the one or more additional memories can be read from and/or written to in a well-known manner. In an embodiment, the memory and the one or more additional memories can be non-transitory computer readable recording media. Memory semiconductors (e.g., DRAMs, etc.) can be means for providing software to the computing device such as the object-based video commenting program program 114. Computer programs, e.g., computer control logic, can be stored in the memory 106.

The VoD database 108 can include video data 110 and user data 112. The VoD database 108 can be any suitable database configuration, such as a relational database, a structured query language (SQL) database, a distributed database, or an object database, etc. Suitable configurations and storage types will be apparent to persons having skill in the relevant. In an exemplary embodiment of the system 100, the VoD data base 108 stores video data 110 and user data 112. The video data 110 can be any video file such as, but not limited to, movies, television episodes, music videos, or any other on-demand videos. Further, the video data 110 may be any suitable video file format such as, but not limited to, .WEBM, .MPG, .MP2, .MPEG, .MPE, .MPV, .OGG, .MP4, .M4P, .M4V, .AVI, .WMV, .MOV, .QT, .FLV, .SWF, and AVCHD, etc. In an exemplary embodiment, the video data 110 may be selected by a user on one or more of the user devices 120a-n and displayed on a display of the user devices 120a-n . The user data 112 may be any data associated with the user devices 120a-n including, but not limited to, user account information (e.g. user login name, password, preferences, etc.), input data received from one or more of the user devices 120a-n to be displayed in association with a video file via the graphical user interfaces 122a-n (e.g. user comments to be displayed), etc. In an exemplary embodiment, the user data 112 can be user comments associated with one or more of the video files of the video data 110. For example, the user data 112 may be user comments associated with a particular episode of a television show stored in the VoD database 108 as part of the video data 110.

The object-based video commenting program 114 can include the video selection module 140, the video display module 142, the video analysis module 144, the user selection module 146, the user input module 148, the user input analysis module 150, and the user input display module 152 as illustrated in FIG. 1b. The object-based video commenting program 114 is a computer program specifically programmed to implement the methods and functions disclosed herein for object-based commenting in a bullet screen. The object-based video commenting program 114 and the modules 140-152 are discussed in more detail below with reference to FIGS. 1b-4.

The user devices 120a-n can include graphical user interfaces 122a-n. The user devices 120a-n may be a desktop computer, a notebook, a laptop computer, a tablet computer, a handheld device, a smart-phone, a thin client, or any other electronic device or computing system capable of storing, compiling, and organizing audio, visual, or textual data and receiving and sending that data to and from other computing devices, such as the VoD database 102 via the network 130. Further, it can be appreciated that the user devices 120a-n may include one or more computing devices.

The graphical user interfaces 122a-n can include components used to receive input from the user devices 120a-n and transmit the input to the object-based video commenting program 114, or conversely to receive information from the object-based video commenting program 114 and display the information on the user devices 120a-n. In an example embodiment, the graphical user interfaces 122a-n uses a combination of technologies and devices, such as device drivers, to provide a platform to enable users of user devices 120a-n to interact with the object-based video commenting program 114. In the example embodiment, the graphical user interfaces 122a-n receives input from a physical input device, such as a keyboard, mouse, touchpad, touchscreen, camera, microphone, etc. For example, the graphical user interfaces 122a-n may receive comments from one or more of the user devices 120a-n and display those comments to the user devices 120a-n. In an exemplary embodiment, the graphical user interfaces 122a-n are bullet screen interfaces that are displayed over the video data 110. Further, in exemplary embodiments, the graphical user interfaces 122a-n are bullet screen interfaces that receive user input, such as textual comments, from one or more of the user devices 120a-n and display the input to the user devices 120a-n as a scrolling object across a display of the user devices 120a-n. FIG. 1c illustrates an example graphical user interface 122a in accordance with exemplary embodiments and will be discussed in further detail below.

The network 130 may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. In general, the network 130 can be any combinations of connections and protocols that will support communications between the VoD server 102, and the user devices 120a-n. In some embodiments, the network 130 may be optional based on the configuration of the VoD server 102 and the user devices 120a-n.

### A First Exemplary Method for Object-Based Commenting in an On-Demand Video

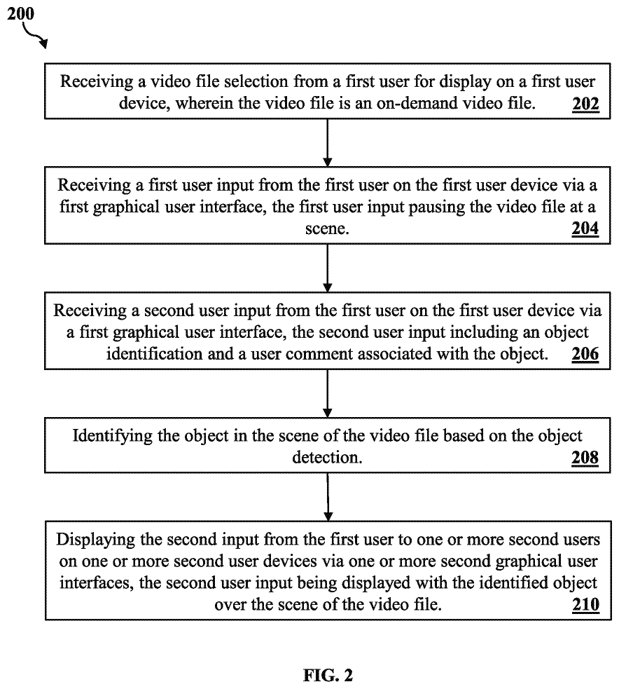

FIG. 2 illustrates a flow chart of an exemplary method 200 for object-based commenting in an on-demand video in accordance with exemplary embodiments.

In an exemplary embodiment, the method 200 can include block 202 for receiving a video file selection from the video data 110 stored on the VoD database 108 by a first user for display on a first user device, e.g. the user device 120a. The video file may be an on-demand video file selected from the video data 110 stored on the VoD database 108 via the graphical user interface 122a by the user on the user device 120a. For example, a first user on the user device 120a may select an episode of a television show stored on the VoD database 108 to view on the user device 120a. The video files stored as the video data 110 on the VoD database 108 can include past user comments, e.g. from one or more second users, associated with one or more objects and/or points of interest in scenes of the video files. The past user comments associated with the video files of the video data 110 can include, for example, user comments from one or more second users who previously watched the video file or from one or more second users who are currently watching the video file but are ahead of the first user by a defined period of time. In an exemplary embodiment, the past user comments associated with the video files of the video data 110 may be displayed in association with a particular object/point of interest such as, but not limited to, a person, an animal, an object, a building, etc. For example, referring to FIG. 1c, a video file may have a past user comment 166, e.g. User A Input 1, which may be displayed on the user interface 122a in association with object 160, e.g. a building in a scene of the video file. Further, in an exemplary embodiment, the graphical user interfaces 122a-n are bullet screen interfaces and the past user comments may not be associated with an object/point of interest and may be displayed on the user devices 120a-n as “bullet” comments where the past user comments scroll across the graphical user interface over the video file. In an exemplary embodiment of the system 100, the video selection module 140 and the video display module 142 can be configured to execute the method of block 202.

In an exemplary embodiment, the method 200 can include block 204 for receiving a first user input from the first user on the first user device, e.g. the user device 120a, via a first graphical user interface, e.g. the graphical user interface 122a. The first user input pauses, or otherwise stops, the video file at a scene. For example, referring to FIG. 1c, the first user, e.g. user B, may pause the video file by pressing the “pause” button in the control panel 174 of the user interface 122a. The first user input may be entered via the graphical user interface 122a using any suitable input device including, but not limited to, a keyboard, a touchpad, a microphone, a camera, a mouse, a remote, a gesture input device, electronic pointer, etc. In an exemplary embodiment of the system 100, the user input module 148 can be configured to execute the method of block 204.

In an exemplary embodiment, the method 200 can include block 206 for receiving a second user input from the first user on the first user device, e.g. the user device 120a, via a first graphical user interface, e.g. the graphical user interface 122a. In an exemplary embodiment, the second user input is received from the user device 120a at the VoD server 102 via the network 130. In an exemplary embodiment, the second user input includes a user comment. For example, referring to FIG. 1c, the first user, e.g. user B, may input the comment 168, e.g. User B Input 1, via the user input box 170 on the first graphical user interface, e.g. the graphical user interface 122a. The user comment of the second user input can be any user input, such as, but not limited to, a textual input, an image file input, an audio input, an emoji, an emoticon, a .gif, or any other suitable user input, etc. In exemplary embodiments, the second user input includes an object identification. The term “object” as used herein may refer to a person, a place, a thing, or any other point/feature of interest in the video. The object identification may be a textual description of the object, e.g. one or more words. For example, the paused scene of the video file may feature a house, e.g. object 160, an actor, e.g. object 162, or a hat, e.g. object 164 and the second user input may include an object identification such as, but not limited to, “house,” “actor,” or “hat.” The object identification may be generic such as the descriptions above or may be more specific and include information such as, but not limited to, the object's color, e.g. blue hat, the object's sex, e.g. male actor, the object's name, e.g. “John Smith,” the object's location in the scene, e.g. actor on the right, etc. For example, if the actor, e.g. the object 160, is known to the first user, the object identification may be the actor's name. The object identification may be separate from or a part of the user's comment in the second user input. For example, if the object identification is separate from the comment, the object identification may appear before or after the comment such as “object identification: comment,” e.g. actor: I like him in this role,” or “comment: object identification,” e.g. “I like him in this role: actor.” The object identification may be indicated as separate from the comment by any suitable means such as a colon, a comma, a hyphen, spacing, font type, font color, font style, etc. If the object identification is part of the comment, the object identification may appear anywhere within the comment such as, but not limited to “I like this actor,” “This actor is great,” “Actor is so good here,” etc. The second user input may be entered via the graphical user interface 122a using any suitable input device including, but not limited to, a keyboard, a touchpad, a microphone, a camera, a mouse, a remote, a gesture input device, electronic pointer, etc. Further, the second user input may be sent to the VoD server 102 using a button, such as the send button 172, on the graphical user interface 122a. In an exemplary embodiment of the system 100, the user input module 148 can be configured to execute the method of block 204.

In an exemplary embodiment, the method 200 can include block 208 for identifying the object in the scene of the video file based on the object identification. In an exemplary embodiment, the object-based video commenting program 114 may use natural language processing (NLP) to analyze the object identification and object detection and to identify the object in the scene. NLP techniques enable computers to derive meaning from human or natural language input, e.g. the second user input. Utilizing NLP, large chunks of text are analyzed, segmented, summarized, and/or translated in order to alleviate and expedite identification of relevant information. For example, the object-based video commenting program 114 may analyze the second user input for keywords in order to identify one or more objects in the second input. Object detection techniques may be, but not limited to, use of a trained object detection model. The trained object detection model may be generated using neural networks, including, but not limited to, deep convolutional neural networks, and deep recurrent neural networks. Deep convolutional neural networks are a class of deep, feed-forward artificial neural networks consisting of an input layer, an output layer, and multiple hidden layers used to analyze images. Deep recurrent neural networks are artificial neural networks wherein the connections between the nodes of the network form a directed graph along a sequence used for analyzing linguistic data. The video analysis module 144 may input the object identification into the convolutional neural networks to generate the trained object detection model. The trained object detection model detects objects within the video file. For example, the video analysis module 144 may input the object identification into the object detection model to detect the subject object of the object identification, e.g. the object 162 identified in the user comment 168. The object-based video commenting program 114 may associate the user comment and the identified object using metadata having a timestamp or frame numbers, for example. In an exemplary embodiment of the system 100, the user input analysis module 150 and the video analysis module 144 can be configured to execute the method of block 208.

In an exemplary embodiment, the method 200 can include block 210 for displaying the second user input from the first user to one or more second users on one or more second user devices, e.g. the user device 120b-n, via one or more second graphical user interfaces, e.g. graphical user interfaces 122b-n. In an exemplary embodiment, the object-based video commenting program 114 displays the user comment contained within the second user input over the scene of the video file via the graphical user interfaces 122b-n. For example, referring to FIG. 1c, the object-based video commenting program 114 can display a user comment in the second user input, e.g. comment 168, from the first user, e.g. user B, on the graphical user interfaces 122b-n on the user devices 120b-n of the one or more second users in association with the object 162. Therefore, the one or more second users will see the second user input from the first user associated with the object 162. Thus, the one or more second users will know that the second user input is in reference to the object 162. In an exemplary embodiment of the system 100, the user input display module 152 can be configured to execute the method of block 210.

### A Second Exemplary Method for Object-Based Commenting in an On-Demand Video

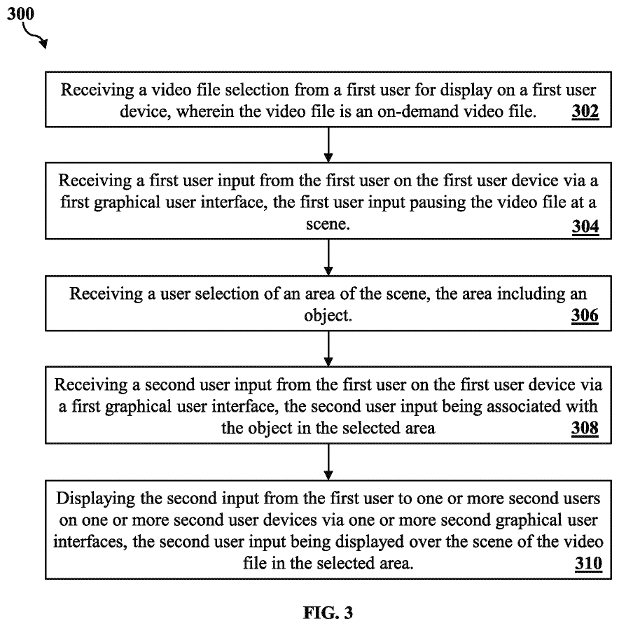

FIG. 3 illustrates a flow chart of an exemplary method 300 for object-based commenting in an on-demand video in accordance with exemplary embodiments.

In an exemplary embodiment, the method 300 can include block 302 for receiving a video file selection from the video data 110 stored on the VoD database 108 by a first user for display on a first user device, e.g. the user device 120a. The video file may be an on-demand video file selected from the video data 110 stored on the VoD database 108 via the graphical user interface 122a by the user on the user device 120a. For example, a first user on the user device 120a may select an episode of a television show stored on the VoD database 108 to view on the user device 120a. The video files stored as the video data 110 on the VoD database 108 can include past user comments, e.g. from one or more second users, associated with one or more objects and/or points of interest in scenes of the video files. The past user comments associated with the video files of the video data 110 can include, for example, user comments from one or more second users who previously watched the video file or from one or more second users who are currently watching the video file but are ahead of the first user by a defined period of time. In an exemplary embodiment, the past user comments associated with the video files of the video data 110 may be displayed in association with a particular object/point of interest such as, but not limited to, a person, an animal, an object, a building, etc. For example, referring to FIG. 1c, a video file may have a past user comment 166, e.g. User A Input 1, which may be displayed on the user interface 122a in association with object 160, e.g. a building in a scene of the video file. Further, in an exemplary embodiment, the graphical user interfaces 122a-n are bullet screen interfaces and the past user comments may not be associated with an object/point of interest and may be displayed on the user devices 120a-n as “bullet” comments where the past user comments scroll across the graphical user interface over the video file. In an exemplary embodiment of the system 100, the video selection module 140 and the video display module 142 can be configured to execute the method of block 302.

In an exemplary embodiment, the method 200 can include block 304 for receiving a first user input from the first user on the first user device, e.g. the user device 120a, via a first graphical user interface, e.g. the graphical user interface 122a. The first user input pauses, or otherwise stops, the video file at a scene. For example, referring to FIG. 1c, the first user, e.g. user B, may pause the video file by pressing the “pause” button in the control panel 174 of the user interface 122a. The first user input may be entered via the graphical user interface 122a using any suitable input device including, but not limited to, a keyboard, a touchpad, a microphone, a camera, a mouse, a remote, a gesture input device, electronic pointer, etc. In an exemplary embodiment of the system 100, the user input module 148 can be configured to execute the method of block 304.

In an exemplary embodiment, the method 200 can include block 306 for receiving a user selection of an area of the scene. The area of the scene contains an object that the user wished to comment on. The first user may select the area via a first graphical user interface, e.g. the graphical user interface 122a. The first user may select the area using any suitable input device including, but not limited to, a mouse, a touchpad, a stylus, a keyboard, a remote, a gesture input device, electronic pointer, etc. For example, the first user may use a mouse connected to the first user device, e.g. the user device 120a, to draw the selection box 165 over an object, e.g. the object 162. In an exemplary embodiment of the system 100, the user selection module 146 can be configured to execute the method of block 306.

In an exemplary embodiment, the method 200 can include block 308 for receiving a second user input from the first user on the first user device, e.g. the user device 120a, via a first graphical user interface, e.g. the graphical user interface 122a. In an exemplary embodiment, the second user input is associated with the selected area of the scene. The second user input may be, for example, received from the user device 120a at the VoD server 102 via the network 130. In an exemplary embodiment, the second user input includes a user comment. For example, referring to FIG. 1c, the first user, e.g. user B, may input the comment 168, e.g. User B Input 1, to be associated with the selection box 165 containing the object 162. For example, the second user input may be input via the user input box 170 on the first graphical user interface, e.g. the graphical user interface 122a, or via a text box on the graphical user interface 122a, etc. The user comment of the second user input can be any user input, such as, but not limited to, a textual input, an image file input, an audio input, an emoji, an emoticon, a .gif, or any other suitable user input, etc. The term “object” as used herein may refer to a person, a place, a thing, or any other point/feature of interest in the video. The object-based video commenting program 114 may associate the second user input and the selected area of the scene using metadata having a timestamp or frame numbers, for example. In an exemplary embodiment of the system 100, the user input module 148 can be configured to execute the method of block 308.

In an exemplary embodiment, the method 200 can include block 310 for displaying the second user input from the first user to one or more second users on one or more second user devices, e.g. the user device 120b-n, via one or more second graphical user interfaces, e.g. graphical user interfaces 122b-n. In an exemplary embodiment, the object-based video commenting program 114 displays the second user input over the scene of the video file via the graphical user interfaces 122b-n. For example, referring to FIG. 1c, the object-based video commenting program 114 can display the second user input, e.g. comment 168, from the first user, e.g. user B, on the graphical user interfaces 122b-n on the user devices 120b-n of the one or more second users in association with the object 162. Therefore, the one or more second users will see the second user input from the first user associated with the object 162. Thus, the one or more second users will know that the second user input is in reference to the object 162. In an exemplary embodiment of the system 100, the user input display module 152 can be configured to execute the method of block 310.

### A Third Exemplary Method for Object-Based Commenting in an On-Demand Video

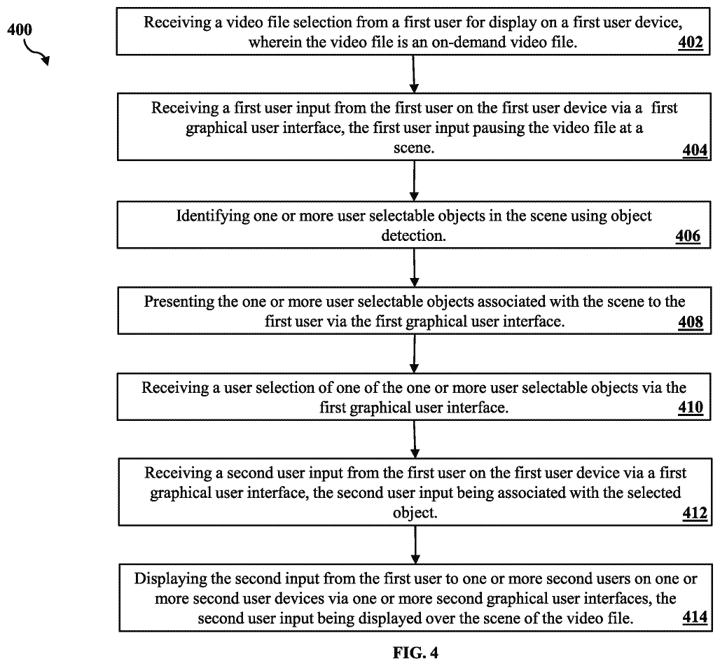

FIG. 4 illustrates a flow chart of an exemplary method 400 for object-based commenting in an on-demand video in accordance with exemplary embodiments.

In an exemplary embodiment, the method 300 can include block 402 for receiving a video file selection from the video data 110 stored on the VoD database 108 by a first user for display on a first user device, e.g. the user device 120a. The video file may be an on-demand video file selected from the video data 110 stored on the VoD database 108 via the graphical user interface 122a by the user on the user device 120a. For example, a first user on the user device 120a may select an episode of a television show stored on the VoD database 108 to view on the user device 120a. The video files stored as the video data 110 on the VoD database 108 can include past user comments, e.g. from one or more second users, associated with one or more objects and/or points of interest in scenes of the video files. The past user comments associated with the video files of the video data 110 can include, for example, user comments from one or more second users who previously watched the video file or from one or more second users who are currently watching the video file but are ahead of the first user by a defined period of time. In an exemplary embodiment, the past user comments associated with the video files of the video data 110 may be displayed in association with a particular object/point of interest such as, but not limited to, a person, an animal, an object, a building, etc. For example, referring to FIG. 1c, a video file may have a past user comment 166, e.g. User A Input 1, which may be displayed on the user interface 122a in association with object 160, e.g. a building in a scene of the video file. Further, in an exemplary embodiment, the graphical user interfaces 122a-n are bullet screen interfaces and the past user comments may not be associated with an object/point of interest and may be displayed on the user devices 120a-n as “bullet” comments where the past user comments scroll across the graphical user interface over the video file. In an exemplary embodiment of the system 100, the video selection module 140 and the video display module 142 can be configured to execute the method of block 402.

In an exemplary embodiment, the method 200 can include block 404 for receiving a first user input from the first user on the first user device, e.g. the user device 120a, via a first graphical user interface, e.g. the graphical user interface 122a. The first user input pauses, or otherwise stops, the video file at a scene. For example, referring to FIG. 1c, the first user, e.g. user B, may pause the video file by pressing the “pause” button in the control panel 174 of the user interface 122a. The first user input may be entered via the graphical user interface 122a using any suitable input device including, but not limited to, a keyboard, a touchpad, a microphone, a camera, a mouse, a remote, a gesture input device, electronic pointer, etc. In an exemplary embodiment of the system 100, the user input module 148 can be configured to execute the method of block 404.

In an exemplary embodiment, the method 200 can include block 406 for identifying one or more user selectable objects in the scene using object detection. Object detection techniques may be, but not limited to, use of a trained object detection model. The trained object detection model may be generated using neural networks, including, but not limited to, deep convolutional neural networks, and deep recurrent neural networks. Deep convolutional neural networks are a class of deep, feed-forward artificial neural networks consisting of an input layer, an output layer, and multiple hidden layers used to analyze images. Deep recurrent neural networks are artificial neural networks wherein the connections between the nodes of the network form a directed graph along a sequence used for analyzing linguistic data. The video analysis module 144 may input an image of the scene into the convolutional neural networks to generate the trained object detection model. The trained object detection model detects objects within the scene of the video file. For example, the video analysis module 144 may input the scene into the object detection model to detect one or more user selectable objects in the scene, e.g. the objects 160, 162, and 164. In an exemplary embodiment of the system 100, the video analysis module 144 can be configured to execute the method of block 406.

In an exemplary embodiment, the method 200 can include block 408 for presenting the one or more user selectable objects, e.g. objects 160, 162, 164, associated with the scene to the first user via the first graphical user interface, e.g. the graphical user interface 122a. For example, the object-based video commenting program 114 may highlight the one or more user selectable objects, or present the one or more user selectable objects with lines surrounding the one or more user selectable objects, etc. In an exemplary embodiment of the system 100, the video display module 142 can be configured to execute the method of block 408.

In an exemplary embodiment, the method 200 can include block 410 for receiving a user selection of one of the one or more user selectable objects via the first graphical user interface, e.g. the graphical user interface 122a. The first user may select the object using any suitable input device such as, but not limited to a mouse, a touchpad, a touchscreen, a stylus, a keyboard, a camera, a microphone, a remote, a gesture input device, electronic pointer, etc. In an exemplary embodiment of the system 100, the user selection module 146 can be configured to execute the method of block 410.

In an exemplary embodiment, the method 200 can include block 412 for receiving a second user input from the first user on the first user device, e.g. the user device 120a, via a first graphical user interface, e.g. the graphical user interface 122a. In an exemplary embodiment, the second user input is associated with the selected object. The second user input may be, for example, received from the user device 120a at the VoD server 102 via the network 130. In an exemplary embodiment, the second user input includes a user comment. For example, referring to FIG. 1c, the first user, e.g. user B, may input the comment 168, e.g., User B Input 1, to be associated with the selected object, e.g. the object 162. For example, the second user input may be input via the user input box 170 on the first graphical user interface, e.g. the graphical user interface 122a, or via a text box on the graphical user interface 122a, etc. The user comment of the second user input can be any user input, such as, but not limited to, a textual input, an image file input, an audio input, an emoji, an emoticon, a .gif, or any other suitable user input, etc. The term “object” as used herein may refer to a person, a place, a thing, or any other point/feature of interest in the video. In an exemplary embodiment of the system 100, the user input module 148 can be configured to execute the method of block 412.

In an exemplary embodiment, the method 200 can include block 414 for displaying the second user input from the first user to one or more second users on one or more second user devices, e.g. the user device 120b-n, via one or more second graphical user interfaces, e.g. graphical user interfaces 122b-n. In an exemplary embodiment, the object-based video commenting program 114 displays the second user input over the scene in association with the selected object, e.g. the object 162, of the video file via the graphical user interfaces 122b-n. For example, referring to FIG. 1c, the object-based video commenting program 114 can display the second user input, e.g. comment 168, from the first user, e.g. user B, on the graphical user interfaces 122b-n on the user devices 120b-n of the one or more second users in association with the object 162. Therefore, the one or more second users will see the second user input from the first user associated with the object 162. Thus, the one or more second users will know that the second user input is in reference to the object 162. In an exemplary embodiment of the system 100, the user input display module 152 can be configured to execute the method of block 414.

### Computer System Architecture

FIG. 5 illustrates a computer system 500 in which embodiments of the present disclosure, or portions thereof, may be implemented as computer-readable code. For example, the VoD server 102 and the user devices 120a-n of FIG. 1a may be implemented in the computer system 500 using hardware, software executed on hardware, firmware, non-transitory computer readable media having instructions stored thereon, or a combination thereof and may be implemented in one or more computer systems or other processing systems. Hardware, software, or any combination thereof may embody modules, such as the modules 140-152 of FIG. 1b, and components used to implement the methods of FIGS. 2-4.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device specifically configured to perform the functions discussed herein. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 2-4, as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

The processor device 504 may comprise one or more modules or engines, such as the modules 140-152, configured to perform the functions of the computer system 500. Each of the modules or engines may be implemented using hardware and, in some instances, may also utilize software, such as corresponding to program code and/or programs stored in the main memory 508 or secondary memory 510. In such instances, program code may be compiled by the processor device 504 (e.g., by a compiling module or engine) prior to execution by the hardware of the computer system 500. For example, the program code may be source code written in a programming language that is translated into a lower level language, such as assembly language or machine code, for execution by the processor device 504 and/or any additional hardware components of the computer system 500. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for authentication of a client device using a hash chain. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for object-based commenting in an on-demand video, the method comprising:
receiving a video file selection from a first user for display on a first user device, wherein the video file is an on-demand video file;
receiving a first user input from the first user on the first user device via a first graphical user interface, the first user input pausing the video file at a scene;
receiving a second user input from the first user on the first user device via a first graphical user interface, the second user input including an object identification and a user comment associated with the object
identifying the object in the scene of the video file based on the object identification; and
displaying the second input from the first user to one or more second users on one or more second user devices via one or more second graphical user interfaces, the second user input being displayed with the identified object over the scene of the video file.

2. A method according to claim 1, wherein identifying the object comprises:
analyzing the user object identification using natural language processing; and
analyzing the scene of the video using and object detection model, the object detection model using a neural network.

3. A method as in claim 1, wherein the object identification is one or more words describing the object.

4. A method as in claim 1, wherein the object is at least one of the group consisting of: a person, an animal, an object, and a building.

5. A method as in claim 1, wherein the second user comment is at least one of the group consisting of: a textual input, an image file input, an audio input, an emoji, an emoticon, and a .gif.

6. A method as in claim 1, wherein the first graphical user interface and the one or more second graphical user interfaces are bullet screen interfaces.

7. A system for object-based commenting in an on-demand video, the system comprising:
one or more processors, one or more computer-readable memories, one or more computer-readable tangible storage devices, and instructions stored on at least one of the one or more storage devices for execution by at least one of the one or more processors via at least one of the one or more memories, the instructions comprising:
instructions to receive a video file selection from a first user for display on a first user device, wherein the video file is an on-demand video file;
instructions to receive a first user input from the first user on the first user device via a first graphical user interface, the first user input pausing the video file at a scene;
instructions to receive a second user input from the first user on the first user device via a first graphical user interface, the second user input including an object identification and a user comment associated with the object
instructions to identify the object in the scene of the video file based on the object identification; and
instructions to display the second input from the first user to one or more second users on one or more second user devices via one or more second graphical user interfaces, the second user input being displayed with the identified object over the scene of the video file.

8. A system according to claim 7, wherein the instructions to identify the object comprises:
instructions to analyze the user object identification using natural language processing; and
instructions to analyze the scene of the video using and object detection model, the object detection model using a neural network.

9. A system as in claim 7, wherein the object identification is one or more words describing the object.

10. A system as in claim 7, wherein the object is at least one of the group consisting of:
a person, an animal, an object, and a building.

11. A system as in claim 7, wherein the second user comment is at least one of the group consisting of: a textual input, an image file input, an audio input, an emoji, an emoticon, and a .gif.

12. A system as in claim 7, wherein the first graphical user interface and the one or more second graphical user interfaces are bullet screen interfaces.

13. A computer program product for object-based commenting in an on-demand video, the computer program product comprising:
a computer-readable storage medium having program instructions embodied therewith, the program instructions executable by a computer to cause the computer to perform a method, comprising:
receiving a video file selection from a first user for display on a first user device, wherein the video file is an on-demand video file;
receiving a first user input from the first user on the first user device via a first graphical user interface, the first user input pausing the video file at a scene;
receiving a second user input from the first user on the first user device via a first graphical user interface, the second user input including an object identification and a user comment associated with the object
identifying the object in the scene of the video file based on the object identification; and
displaying the second input from the first user to one or more second users on one or more second user devices via one or more second graphical user interfaces, the second user input being displayed with the identified object over the scene of the video file.

14. A computer program product according to claim 13, wherein identifying the object comprises:
analyzing the user object identification using natural language processing; and
analyzing the scene of the video using and object detection model, the object detection model using a neural network.

15. A computer program product as in claim 13, wherein the object identification is one or more words describing the object.

16. A computer program product as in claim 13, wherein the object is at least one of the group consisting of: a person, an animal, an object, and a building.

17. A computer program product as in claim 13, wherein the second user comment is at least one of the group consisting of: a textual input, an image file input, an audio input, an emoji, an emoticon, and a .gif.

18. A computer program product as in claim 13, wherein the first graphical user interface and the one or more second graphical user interfaces are bullet screen interfaces.

19. A method for object-based commenting in an on-demand video, the method comprising:
receiving a video file selection from a first user for display on a first user device, wherein the video file is an on-demand video file;
receiving a first user input from the first user on the first user device via a first graphical user interface, the first user input pausing the video file at a scene;
receiving a user selection of an area of the scene, the area including an object;
receiving a second user input from the first user on the first user device via a first graphical user interface, the second user input being associated with the object in the selected area; and
displaying the second input from the first user to one or more second users on one or more second user devices via one or more second graphical user interfaces, the second user input being displayed over the scene of the video file in the selected area.

20. A method for object-based commenting in an on-demand video, the method comprising:
receiving a video file selection from a first user for display on a first user device, wherein the video file is an on-demand video file;
receiving a first user input from the first user on the first user device via a first graphical user interface, the first user input pausing the video file at a scene;
Identifying one or more user selectable objects in the scene using object detection;
presenting the one or more user selectable objects associated with the scene to the first user via the first graphical user interface;
receiving a user selection of one of the one or more user selectable objects via the first graphical user interface;
receiving a second user input from the first user on the first user device via a first graphical user interface, the second user input being associated with the selected object; and
displaying the second input from the first user to one or more second users on one or more second user devices via one or more second graphical user interfaces, the second user input being displayed over the scene of the video file.
